(19) United States
(12) Patent Application Publication
(10) Pub. No.: US 2009/0172157 A1
(43) Pub. Date: Jul. 2, 2009

(54) Method and Device for Content Transmission on P2P Network

(76) Inventor: Yongmin Zhang, Guangdong (CN)

Correspondence Address: GLOBAL IP SERVICES, 7285 W. Eagle Court, Winton, CA, 95388, US

(21) Appl. No.: 12/297,725

(22) PCT Filed: Apr. 21, 2006
(86) PCT No.: PCT/CN2006/000769

§ 371 Date: Oct. 20, 2008

(51) Int. Cl. G06F 15/173; G06F 15/16

(52) U.S. Cl. 709/224; 709/236; 709/227

(57) ABSTRACT

This invention discloses a method and device for content transmission on P2P network, including: dividing the content into multiple blocks and mark each of them; dividing nodes participating in content transmission into at least two groups; selecting part or all members from the content-transmitting groups to participate in the distribution of the blocks, in which the nodes respectively transmit the distributed blocks to part or all members of the corresponding content-receiving groups; controlling the members of the content-receiving groups who have received the blocks to transmit the content to other members in the their own group. In this invention, the nodes are divided into groups, the content blocks are actively transmitted between groups, and the members in the same group also can exchange content blocks actively through management of the control dataset, therefore, the node can fully schedule the resources of each node without interrogating the other nodes. Thus the real-time performance of transmission can be enhanced.

### FIELD OF THE INVENTION

This invention relates to a computer network, in particular to a method and device for content transmission or distribution on P2P network.

### BACKGROUND

A content source end for the traditional P2P transmission is a node, that means the source node transmits contents to other nodes by blocks, and then the other nodes transmit these content blocks again. When the content is distributed on various nodes, some improvement is required. An improvement method is named as BitTorrent technology. The node can take content blocks from other nodes. However, this method functions well when it is used for P2P download of the relatively self-governing file of the node. If this method is used in the system that the content is divided into a plurality of blocks for transmission, it is required to interrogate the other nodes if they have this content block when it requires other nodes to transmit the content block, and then to establish connection. Thus the disadvantage of this method is that its real-time performance is poor, so that it is hard to schedule resources of each node.

### CONTENT OF THE INVENTION

This invention mainly aims to solve the existing technical problems, and provides a method and device for content transmission on P2P network to make full dispatching of the resources of each node. There is no need to interrogate other nodes, and thus the improvement of real-time performance for content transmission is achieved.

The secondary objective of this invention is to provide a method and system for content transmission to make further full use of the resources of each node for increasing the content transmission rate on P2P network to avoid network congestion.

For achieving the objective above, this invention discloses a method for content transmission on P2P network. The used technical scheme is: divide the nodes transmitting the content into a plurality of groups, and adopt inter-group P2P transmission method named as inter-group transmission, and its inter-group content transmission is named for short as transmission; and the P2P transmission method adopting distribution tree to the members in this group is named as intra-group exchange method, and the transmission that its member transmits the content block to the other members in this group is named for short as exchange. Generally, the content is divided into blocks, and then the content block is dispersively transmitted to other groups by each member of the group with content After transmission, the content blocks dispersively exist in the group received the content block, and then the members in the group exchange the content blocks to make all the members in this content-receiving group receive the whole content.

The node is the treating position in the network. In P2P network, the node can be a computer, server or gateway.

Supposing that the group is marked as Gᵢ: the group responsible for transmitting the content is named as content-transmitting group, and the group responsible for receiving the content is named as content-receiving group.

The content-receiving groups after receiving the content block can be changed to the transmission group and transmit the content block to other groups. It can be understood as:
Server=>Gₙ=>Gₙ₋₁=> . . . =>G₁

The transmission between the groups above can be in series relation and with one-to-many transmission relation. For example:
Gᵢ= [symbol] (Gⱼ₁m Gⱼ₂, . . . , Gⱼₖ)

That is to say, one group can synchronously transmit the content to multi groups.

The sequence of the transmission group follows one or more of the following principle(s):

A. The groups received part of content have the priority to transmit the said content to the groups which never receive content;

B. The group closer to the previous source end transmits the content to the farther groups. The main method to determine the distance is to evaluate the average time of data round-trip between the members of the group with the previous source end;

C. The group with better transmission quality transmits the content to the group with poor transmission quality;

D. The group with faster transmission rate transmits the content to the group with slower transmission rate;

E. The group established earlier transmits the content to the group established later.

For making full use of the capacity of each member in the group, the preference is that the transmission group distributes the content blocks separately for each member when transmitting the content. In the same way, for making full use of the exchange capacity of each member in the group, the content blocks which are transmitted to the content-receiving group exists separately in the members.

In the environment of P2P network, for inter-communication, the nodes require to know the related information about other nodes, e.g. the necessary data for communication.

One group including the transmission group may have one or more member(s), and the member(s) can be the server.

The detailed technical steps adopted to solve the technical problems are as below:

A1. Divide the content to be transmitted into a plurality of blocks and mark each of them;

B1. Divide the nodes transmitting the content into at least two groups;

C1. Select part or all of the members from the transmitting groups with content blocks to participate in the distribution of the blocks, and the members respectively transmit the distributed blocks to part or all of the members of the content-receiving groups requiring the content blocks;

D1. Control the members received the blocks in the content-receiving groups retransmit the content blocks to other members requiring the content blocks in the group.

The content-receiving group that received the blocks in step D1 becomes the new transmitting group and transmits the blocks to other groups according to step C1.

The further improvement of this invention also includes the following grouping steps:

B11. When node login is detected, firstly locate this node to the stream whose rate is in conformity with its download rate;

B12. Search for the groups which have the same location with the starting point of the transmission requested by the node;

B13. Search for the groups which have the same property requested by the node in the groups with the same location;

B14. Search for the proper group in the groups with the same property and add the node into the group.

Herein, in step B14, if there is no stream in conformity with its download rate and such stream cannot be created, then the node will be positioned the stream at lower download rate.

Herein, if there are no groups with the same location as mentioned in step B12, or there are no groups with the same property as mentioned in step B13, then create a new group whose property is in conformity with the node and add the node into the newly created group.

Herein, the steps after step B14 include the following steps: if the number of the group members added by this node is larger than or equals to the predetermined value, then create a new group with the same property and add the node into the newly created group.

For adapting to some transmission types, without changing original groups, an existing group is divided into two or more groups, meaning that the members of one group are divided into many groups (sub-group). For example, if one member in the group transmits data to other members, then the transmitting member is the transmitting group and the other members are content-receiving groups.

When the said member of the content-transmitting group in step D1 transmits the content blocks, it distributes the content blocks depending on the control dataset of the transmitting group and the control dataset of the content-receiving group; when the said member of the content-receiving group in step E1 receives the content blocks from transmitting group, it transmits the received content blocks to other members in the group depending on the control dataset in the group.

In the steps above, further including the following steps: control the members in the same group to have the same control dataset, and control the transmitting member of the transmitting group to have the control dataset of the said content-receiving group.

Herein, continuous update for the control dataset is required. Therefore, it also includes the control dataset maintaining step:

A2. The server monitors the connection, disconnection and communication state of the nodes that have participated in transmission contents; the changes are recorded in the control dataset; mark the control dataset after changed;

B2. Transmit the updated control dataset to each node.

In step B2, the method of the server transmitting the changed control dataset to the node to be updated includes the following steps:

A3. Depending on the existing control dataset, the server divides the control dataset or changed part of the control dataset or generated variation of the control dataset into blocks, and respectively transmits each block to part or all members of the group;

B3. If the member has no former control dataset, the server transmits the whole control dataset or variation generated by the control dataset to the member, or retrieves the former related control dataset.

In the steps above, when sending content blocks, pack the content blocks and add the additional information including content marks and block number for the receiver receiving them and reintegrating them.

It further includes the following steps: after the data is received by the node, record the block number of the last received content block; when the node is logged in again, determine the part of the content which the node is belong to according to the last received block number, and combine the nodes belonging to the same part of content into a session group; the group that has received content blocks is in charge of sending the content blocks to the groups requiring the content, and if there isn't any group that has received the required content blocks, the server is in charge of sending the content blocks.

It also includes the following steps: record the transmitting states of the content blocks received by the member on the control dataset, the transmitting member determines whether the receiving member already has the content block before sending the content block according to the transmitting state of the control dataset, and if yes , the content to be sent should be null.

In the steps above, when the content blocks are sent in the content-receiving group, it includes the following steps: divide the members in the group into subgroups depending on the control dataset in the group and each subgroup includes at least one member; when sending content blocks, the transmitting group transmits the corresponding content blocks to all the members of a subgroup in the group at the same time.

In the content-receiving group, it is preferred that the content block are sent according to the following steps: if the number of the members in the group is less than or equal to the predetermined value, the said member will transmit the content blocks one by one directly to other members in the group; if the number of the members in the group is larger than the predetermined value, the said member will transmit the content blocks in distribution tree mode. The said distribution tree has dynamic structure, that is to say the content block is distributed to one group of the selected members. The said selected members retransmit the distributed content to the members at next lower level.

It also includes the following steps: the server monitors the network connection of each member node and calculates the upload rate coefficient MUⱼ of each member node; assigning upload rate coefficient Uⱼ for the member node according to the upload rate coefficient, in which the said upload rate coefficient MUⱼ is the ratio of the max upload rate that can be used for content transmission of the member node to the base rate U_{bass}, in which j=1,2 . . . N, and N is the number of the nodes that have participated in the transmission; determining the transmission rate D of the content stream and the number L of the content stream at the source end, in which the transmission rate D of the said content stream and the number L of the content stream at the source end can be variables or constants under different conditions, and the said selected upload rate coefficient Uⱼ satisfies both of the following two relations:

(U₁+ . . . +U_{N})*U_{bass}+L*D≧f(N*D)

Uⱼ≦MUⱼ

Wherein, f (N*D) means the function of N*D, which is the bandwidth required for total download; and

D≦maximum transmission rate of content stream used by the content source end when transmitting one content stream;

L*D≦sum of maximum upload bandwidth for the content transmission provided by all the nodes of the content source end;

distributing the content blocks for transmission to the member node according to the selected upload rate coefficient, in which the number of content blocks for transmission is proportional to the selected upload rate coefficient assigned by the server to the member node.

For achieving the objectives above, this invention discloses a computer readable medium with computer executable program. The said program can be executed by computer to accomplish the functions above.

For achieving the objectives above, this invention discloses a computer readable medium with computer executable program. The said program can be executed by computer to accomplish the functions above though.

For achieving the objectives above, this invention discloses a device for content transmission on P2P network, comprising:

Content blocks generating module: for dividing the content required to be transmitted into a plurality of content blocks and marking each content block; group generating module, for dividing the nodes transmitting the contents into at least two groups; transmission module, for transmitting the contents to the nodes by blocks; Inter-group transmitting control module: for selecting part or all the members from the content-transmitting groups with content blocks to participate in the distribution of the content blocks, and controlling the member to respectively transmit the distributed content blocks to part or all members of the content-receiving groups that require the content blocks through transmission mode; intra-group transmitting control module: for controlling the members received the content blocks in the content-receiving groups to retransmit the content blocks to other members that require the content blocks in the group.

It also includes detection module and control dataset creating and maintaining module, the said detection module monitors the connection, disconnection and communication state of the nodes transmitting the content; the control dataset creating and maintaining module is for creating the corresponding control dataset of the properties of each node in the recording group for each group, in which the control dataset at least includes the necessary data for the communications between the nodes, transmission state, group property and the marks to indicate the change of the control dataset; control dataset creating and maintaining module updates the control dataset according to the changes monitored by the detection module and marks the control dataset after changed; content block generating module divides the changed part of the updated control dataset or variation of the control dataset into blocks, and inter-group transmission module respectively transmits the blocks to part or all members of the group; intra-group transmission control module controls the members to retransmit the blocks received from the server to other members in the group.

The said intra-group transmission control module includes a grouping unit in the group, which are used for dividing the members in the group into a plurality of subgroups according to the control dataset in the group, each subgroup including at least one member. When transmitting group is sending content blocks, the same content blocks should be transmitted to all members in the certain subgroup of the content-receiving group at the same time. The said intra-group transmission control module also includes a transmission decision making unit, which is used for detecting the number of the members in the group and for controlling the said members with the content blocks to directly transmit the content blocks to other members in the group one by one when the number of the members is lower than or equals to the predetermined value; and transmit the content blocks in multilevel distribution tree mode when the number of the members is higher than the predetermined value, in which the said distribution tree is dynamically structured.

Further improvement of the scheme is: including a member upload rate coefficient calculating module and a content block distribution module. The said detection module monitors the network connection of each member node and transmit the upload rate of each member node to the member upload rate coefficient calculating module for calculating the upload rate coefficient of each member node, in which the said upload rate coefficient is the ratio of the max upload rate of the member node that can be used for transmission to the base rate. a selected upload rate coefficient is assigned according to the calculated upload rate coefficient and is recorded in the relevant control dataset; the content block distribution module distributes the content blocks that can be sent to the member node according to the selected upload rate coefficient, and the number of the said content blocks that can be sent is proportional to the selected upload rate coefficient of the member node given by the server.

For achieving the objectives above, this invention discloses a method for content transmission on P2P network, comprising the following steps:

A5. Dividing the content to be transmitted into a plurality of blocks and mark each of them;

B5. Dividing the nodes transmitting the content into at least two groups;

C5. Selecting part or all members from the transmitting groups to participate in the distribution of the blocks, and the selected members respectively transmit the distributed blocks to part or all members of the corresponding content-receiving groups which require the said content blocks;

D5. Controlling the members received the blocks in the content-receiving groups to retransmit the content blocks to other members requiring the content blocks in the group;

In step C5 and D5, content blocks are distributed through the following steps when sending content blocks:

E5.The server monitors the network connection of each member node and calculates the upload rate coefficient MUⱼ of each member node; assign an upload rate coefficient Uⱼ for the member node according to the upload rate coefficient, and the said upload rate coefficient MUj is the ratio of the max upload rate that can be used for content transmission of the member node to the base rate U_{bass}, in which j=1,2 . . . N, and N is the number of the nodes that have participated in the transmission; determine the transmission rate D of the content stream and the number L of the content stream at the source end. The transmission rate D of the said content stream and the number L of the content stream at the source end can be variables or constants under different conditions. The said selected upload rate coefficient Uⱼ satisfies both of the following two relations:

(U₁+ . . . +U_{N})*U_{bass}+L*D≧f(N*D)

Uⱼ≦MUⱼ

In the relations above, f (N*D) means the function relating to N*D, and is the bandwidth required for total download; and

D≦maximum transmission rate of content stream used by the content source end when transmitting one content stream;

L*D≦summation of maximum upload bandwidth for the content transmission provided by all the nodes of content source end;

F5. Distributing the content block for transmission to the member nodes according to the selected upload rate coefficient. The number of content block for transmission is proportional to the selected upload rate coefficient assigned by the server to this member node.

For achieving the objective above, this invention discloses a device for content transmission on P2P network, comprising:

Content block generating module: for dividing the content required to be transmitted into a plurality of content blocks and marking each content block; group generating module: for dividing the nodes transmitting the contents into at least two groups; transmission module: for transmitting the content including the control dataset to the nodes by blocks;

Inter-group transmission control module: for selecting part or all the content-transmitting groups with content blocks to participate in the distribution of the content blocks, and controlling the member to respectively transmit the distributed content blocks to part or all members of the content-receiving groups that require the content blocks through transmission module;

Intra-group transmitting control module: for controlling the members that have received the content blocks in the content-receiving groups to retransmit the content blocks to other members that require the content blocks in the group;

Member upload rate coefficient calculating module: it calculates the upload rate coefficient of each member node according to the upload rate of each member node, the said upload rate coefficient is the ratio of the max upload rate that can be used for transmission to the base rate of the member node, and it distributes a selected upload rate coefficient according to the calculated upload rate coefficient.

Content block distribution module: it distributes the content blocks for transmission to the member node according to selected upload rate coefficient, and the total number of content blocks for transmission distributed to the member nodes is proportional to the selected upload rate coefficient assigned to the member node. When the upload rate coefficient on the member node is zero, it doesn't distribute the transmission content block to the member nodes to prevent this member from uploading.

For achieving the objective above, this invention discloses a method for content transmission on P2P network, which characterized in the following steps:

A6. Regularly checking on the content with continuous changes. In cases of change, mark the content to indicate the content change at this moment, and extract the changed content part, generate variation of the content, content variation includes the mark indicating the content change;

B6. Taking the variation of the content as the transmission content, divide the said transmission content into a plurality of content blocks and mark each of them;

C6. Dividing the node transmitting the content into at least two groups;

D6. Selecting part or all members from the transmitting groups to participate in the distribution of the blocks, and the selected members respectively transmit the distributed blocks to part or all members of the corresponding content-receiving groups which require the said content blocks;

E6. Controlling the members received the blocks in the content-receiving groups to retransmit the content blocks to other members requiring the content block;

After step E6, the members obtained the variation of the content generates the changed contents based on the variation of the content, it includes the flowing steps:

F61. According to the mark indicating the content change, determining if the member has the corresponding old content. If yes, performing step F62. Otherwise, performing step F63;

F62. Based on the variation of the content and the corresponding old content, generating the new content after changed, and then perform step F64;

F63. Retrieving the corresponding old content and then performing step F62;

F64. Saving the new content after changed and the mark indicating the content for using later. Beneficial effects of this invention: 1) this invention divides the nodes into groups, and performs management through the control dataset. The content blocks are transmitted actively between groups. Members of the group actively exchange the content blocks through the management on control dataset. The node needn't to inquire the other nodes, to fully dispatch the resources of each node, and thus improve the real-time performance for the content transmission. 2) Intra-group content block exchange method is determined based on the number of intra-group members to avoid long delay and to make full use of the upload bandwidth. In addition, it ensures the scale of group. 3) Inter-group and/or intra-group content block transmission of this invention adopts a method for dispatching the content block number of nodes for transmission according to the upload rate coefficient. Therefore, it makes full use of the upload bandwidth of each node, and distributes a more reasonable and fair number of the content block for transmission to each node.

The features and advantages of the invention are described in detail through embodiments in conjunction with the accompanying drawings.

### BRIEF DESCRIPTION OF DRAWINGS

FIG. 1 is a structured block diagram according to an embodiment of the invention;

FIG. 2 is a flow chart according to an embodiment of the invention;

FIG. 3 is an illustration of inter-group transmission according to an embodiment of the invention;

FIG. 4 is a flow chart of intra-group transmission according to another embodiment of the invention;

FIG. 5 is a chart of intra-group members' relationship according to an embodiment of the invention;

FIG. 6 is an illustration of intra-group content block transmission route according to an embodiment of the invention;

FIG. 7 is a structured block diagram of transmission at upload rate coefficient according to an embodiment of the invention;

FIG. 8 is a flow chart of transmission at upload rate coefficient according to an embodiment of the invention;

FIG. 9 is a flow chart according to a preferred embodiment of the invention;

FIG. 10 is a flow chart of sub-group according to an embodiment of the invention.

### EMBODIMENTS OF THE INVENTION

In embodiment 1, when a group transmits content to other groups, it requires to allocate the content block, meaning that to appoint part or all members of the transmission group to transmit the content block of its own respectively. When allocating, it needs to know the information about the transmitting members. Most information is provided by the user management server. For convenience, allocating content is mainly accomplished by the user management server. It needs to notify the members for transmission of the result of the allocation. The method of notifying can be various with deferent conditions.

One of the frequently used methods is to notify the member of a distribution table.

After distribution of the content blocks, the members of the transmission group start to transmit the distributed content blocks. At this time, it needs notify the members of which member the content blocks are transmitted to. The notifying method varies with different environments. One of the frequently used methods is to notify the members of a transmission table or a routing table.

When content block is transmitted to a member of the content-receiving group, it may be required to retransmit. It needs to notify the member of the target user for retransmission. The notifying method varies with different environments. One of the adopted methods is to transmit a user table for retransmission in addition while transmitting the packaged content block. The user table should consist of the necessary data for communication. This method is applicable when the number of the users for retransmission is small; the second adopted method is that the members of the content-receiving group maintain the related transmission table or routing table. The related transmission table or routing table can be one or more than one, the content blocks transmitted from different members use different transmission table or routing table, which can be for public or private use. This method needs to dynamically maintain the transmission table or routing table.

The notifying methods above can be used for the content transmission on P2P network. However, it still needs use an improved and more advanced method that is the monitoring and upgrading method of control dataset of this invention: each group has a control dataset, each member real-time maintains the related control dataset which many operations rely on t. In this paper, the control dataset indicates a group of tables formed by user's related information, including the related communication and state data of each node, and the data relating to control policy.

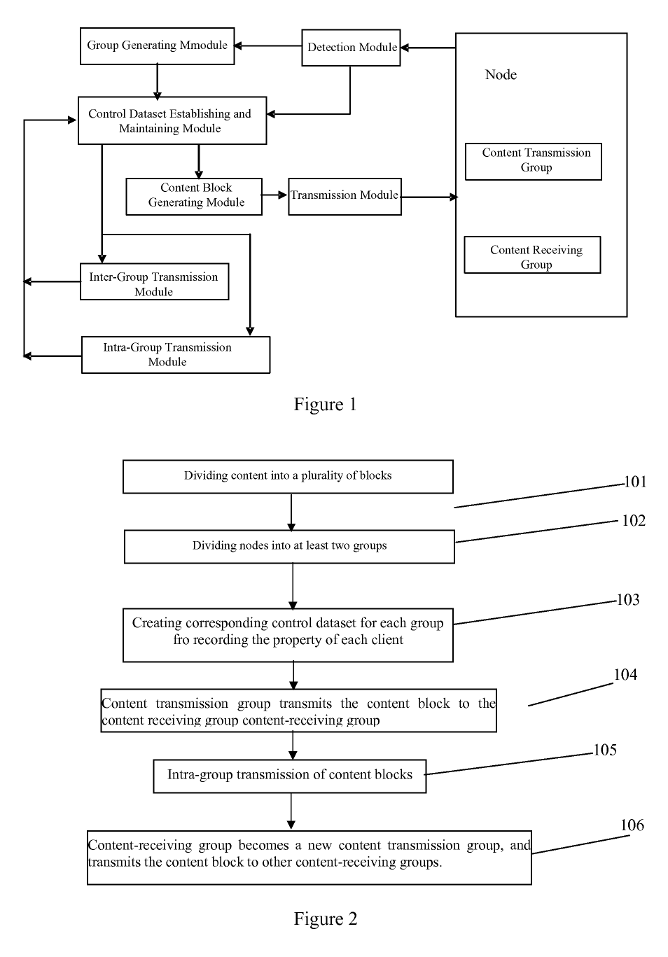

As shown in FIG. 1, the content block generating module on the server divides the content required to be transmitted by the node into a plurality of content blocks and mark each of them, e.g. to mark block number on each block. When the content block is transmitted through the transmission module, it packages the content block with the related information for transmission so that the node can recombine the content blocks into the original content according to the content number after receiving the content blocks, and it can detect the dropped content blocks based on the block number. The content can be audio/video data, computer file, real-time information or UDP data package on network.

The detection module detects the connection state of the node, e.g. login, exit and connection quality of the node.

The group generating module divides the nodes transmitting content into at least two groups according to the information detected by the detection module. The node transmitting contents indicates the node which has accessed to the server and transmitted the contents, including the node receiving content blocks and transmitting the content blocks; each group at least includes one node; the server can be regarded as a group with only one member; the group which has content blocks and can transmit the content blocks to other groups is the content-transmitting group, and the group receiving content blocks from the transmitting group is named as the content-receiving group.

The control dataset creating and maintaining module creates the control dataset recording the property of all the members in the group for each group; the control dataset is transmitted to the nodes by the transmission module through adopting the transmission method, in which the control dataset is divided into multi blocks by the content block generating module, and then is transmitted to the node by the transmission module; nodes in the each group have the common control dataset, i.e.. The control dataset of this group; according to the detected information by the detection module, the change of state of members in the group (e.g. login or disconnection of node) will be reported to the control dataset. At this time, the control dataset creating and maintaining module will update the control dataset in real time.

Inter-group transmission control module selects part or all the members from the content-transmitting group according to the control dataset to transmit content blocks and select the content reviving group to receive the content blocks, and reports the result of the selection to thee control dataset, mark the member responsible for transmitting the content blocks on the control dataset, and transmits the control dataset of the content-receiving group to the members of this content-transmitting group ,so that the members of this content-transmitting group distribute the content blocks depending on the control datasets of the content-transmitting group and the content-receiving group while transmitting the content.

The intra-group transmission control module controls the members received the content block in the content-receiving group according to the control dataset to retransmit this content block to the other members in this group requiring this content block according to the control dataset. The transmission of content blocks between members of the group is based on the control dataset in this group, and the content block received is retransmitted to other members of this group. The content-receiving group received the content block can become the new content-transmitting group for transmitting the content block to the group requiring this content block.

The flow chart of this embodiment using P2P network for content transmission as shown in FIG. 2 consists of the following steps:

In step 101, dividing the content to be transmitted into multi blocks and mark each of them, e.g. adding block number, in which it is preferred that the block size is same, but it also can be different, and then performing step 102;

In step 102, dividing the nodes transmitting the content into at least two groups, and then perform step 103;

In step 103, creating control dataset for each group. The control dataset at least consists of the necessary data, transmission state, group property for the use of communication between each nod and mark indicating the change of control dataset; and then performing step 104;

In step 104, select part or all members from the content-transmitting groups with content block to participate in the distribution of the blocks, in which the said members respectively transmit the distributed blocks to part or all members of the corresponding receiving groups. The content block can be transmitted to one content-receiving group, or multi content-receiving groups, and then perform step 105;

In step 105,controlling the members received the said block in the content-receiving group to retransmit the said content blocks to other members requiring the said content block in the group based on the control dataset of its group, and then performing step 106;

In step 106, the content-receiving group becomes the new content-transmitting group for transmitting the content block to the other content-receiving groups which require the content block.

In the flow mentioned above, alternatively the step 101 can be after the step of dividing the group.

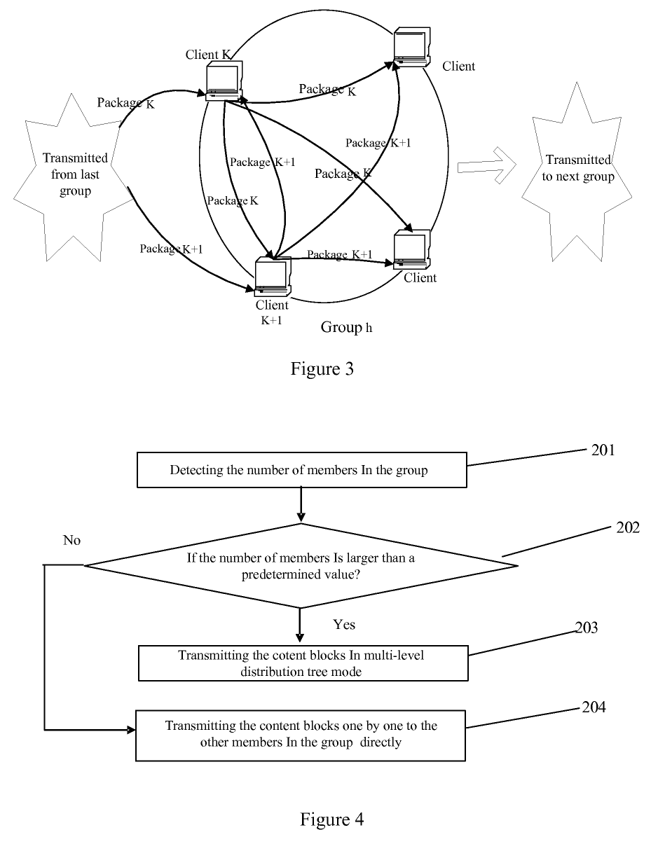

The content transmission by the group is shown as FIG. 3. After transmission, the content blocks are dispersed, that is to say some members in the content-receiving group respectively get part of the contents.

Normally, the members in each group are not recommended in a large number for the convenience of updating control dataset and increasing the exchange rate of the intra-group members. It can be applicable that more groups can be used for satisfying the demand of increasing users.

For adapting to some transmission types, the members of one group can be divided into many groups (sub-group). When one member in the group transmits data to other members, the transmitting member belongs to the transmitting group and the other members belong to the content-receiving group.

It is necessary that the control dataset is maintained in real time, that is to say that the control dataset of each member is latest synchronously. Moreover, for practicality, the maintenance for the control dataset must need low operation overhead. For the reasons above, the following measures are adopted:

a. Transmitting the changing part of the control dataset;

b. Transmitting them in way of P2P.

Generally, it needs to refer to an old control dataset, when transmitting the changing part of the control dataset. When the control dataset is changed the mark for indicating changes will be added for distinguishing the new control dataset with the old one.

The detailed steps for the maintaining the control data set are as below:

1) The server monitors the connection, disconnection and communication state of the nodes transmitting the contents; the changes are recorded in the control dataset through marking the changed control dataset, that is to say: the server regularly check on the content with continuous changes, when it occurs to any change, the server marks the content to indicate the content change at this moment, and extracts the changed part of the content, generates variation of the content, in which the variation of the content includes the mark indicating the change of the content;

2) Transmitting the updated control dataset to each node.

The control dataset of the node is updated with the updated control dataset through the following preferred steps:

2.1) Taking the variation of the content as the transmission content, and dividing the said transmission content into a plurality of content blocks and mark each of them;

2.2) Dividing the nodes transmitting the content into at least two groups;

2.3) Selecting part or all members from the transmitting groups to participate in the distribution of the blocks, and the members respectively transmit the distributed blocks to part or all members of the content-receiving groups which require the said content blocks;

2.4) controlling the receiving groups received the blocks to retransmit the content blocks to other members requiring the content blocks in the group based on the corresponding control dataset

2.5) After step 2.4), the members which received the variation of the content generate the corresponding changed content based on the variation of the content, in which comprising the flowing steps:

2.5.1) Determining whether the member has the corresponding old content according to the mark indicating the content changed. If yes, performing step 2.5.2). Otherwise, performing step 2.5.3);

2.5.2) Generating the new content after changed based on the variation of the content and the corresponding old content, and then performing step 2.5.4);

2.5.3) Retrieving the corresponding old content, and then performing step 2.5.2);

2.5.4) Saving the new content after changed and the mark indicating the content for use later.

If the members have no the previous control dataset, the server will transmits the whole control dataset or the variation of the control dataset to this member.

It can significantly reduce the overhead and make the system bear the group with large number of users by only transmitting the changing part of the control dataset overhead. For example: if 10,000 users login and logout during an hour in a user group, the average number of the changing users per second is: r=10000*2/3600=5.56. The length of each control data record is p bytes, the supplementary information coefficient for transmitting the changing part is f (f<0. 1 can be used for all), then the member is required to be with bandwidth of:

W=r*p*(1+f)

In which, supposing p=20, f=0.1, then

W=5.56*20*1.1=122.32 (bytes/second)

W≦1k (bps), this overhead for wide band network transmission is very low.

It can significantly reduce the overhead of the server by adopting only transmitting the variation of the control dataset on P2P.

By adopting the method mentioned above to maintain the control dataset, it can simplify the transmission operation and increase the number of P2P parallel transmission users, at the same time it can contribute to the system being in large scale, easily being expanded and implemented.

With the control dataset, the transmission group divides the content blocks depending on the control dataset of the transmission group, and the members transmit the content blocks depending on the control dataset of the content-receiving group, the member of the content-receiving group exchange the content blocks depending on the control datasets of their groups.

In the flow above, when transmitting the content blocks, it packages the content blocks and adds the additional information including content marks and block number for the receiver receiving and recombining, and also add the transmission level parameter to indicate if the receiving party is required to retransmit and which transmission mode is adopted.

In the technical scheme, incorporating with using the control dataset, it can use a retransmission level parameter when the content blocks are packaged its function is: when a node receives a content block, it determines if retransmission is required according to the retransmission level parameter. The other method is: to determine if it comes from the source end. Obviously, using retransmission level parameter contributes to a higher efficiency.

The setting of the level parameter varies from different environments. For example, the parameters can be set to the following levels:

Level 0: No retransmission is required.

Level 1: Retransmission is required. During transmission, the level parameter of the content block to be transmitted is lowered to a Level 0.

Level 2: Double retransmission is required. During transmission, the level parameter of the content block to be transmitted is lowered to a Level 1.

If the node is able to store content, the node records the block number for the last content block received after receiving the data; when the node logins again with the block number for the last content block received, it determines which content the block belongs to according to the said block ID, and forms the nodes belonging to the same part of content to the dialogue group; the group received the content block are responsible for transmitting the content block to the groups required the content. If there is no the group received the required content block, the server is responsible for transmitting the content block.

The transmission state of the content block received by the members can be further recorded in the control dataset, the members for transmission determine if there has been this content block in the receiving members before transmitting the content block. If yes, the content for this transmission is null.

The differences between embodiment 2 and the embodiment 1: Intra-group transmission module also includes a grouping unit. The grouping unit divides the members in the group into multiple groups (subgroups) depending on the control dataset of the group, each subgroup at least includes one member; the content block is transmitted in the group through the following steps: the member received a content block from the previous node transmits the content block to all the members of a certain subgroup.

If there are more members in the subgroups of the group, it is preferred that the number of members for each group is fixed for the convenience of being implemented by program.

When the source end transmits the content block to each node and the node is required to exchange content block for retransmission, the following problems can be caused:

Then node transmits the content block to other nodes one by one. In case of large number of nodes, it will occur to long delay.

When the node adopts distribution tree to transmitting the content block to other nodes, the number the related to the distribution tree is small, and the efficiency is poor. When node adopts distribution tree to transmit the content to other nodes, and the other members in the group are involved, it is possible that the upload bandwidth can't be used fully. Another situation maybe is that the group scale is small.

This embodiment adopts the following scheme to perform the exchange of content block in the group:

a. The members of the group have a same and updated control dataset in real time, which the exchange between members is relying on.

b. Active transmission.

c. If the number of members in the group is small, the simple transmission one by one is adopted; if the number of group members is large, the distribution tree for cooperative transmission is adopted.

d. It can closely incorporate with the inter-group transmission to attain the best effect.

Firstly, all of the exchanges are depending on a control dataset updated in real time. The group members can be aware of the positions of the other members with the control dataset. The members transmit some of the existed content blocks (obtained through the transmission or designated by the system) to the other members, so that the other members can receive some part of the content.

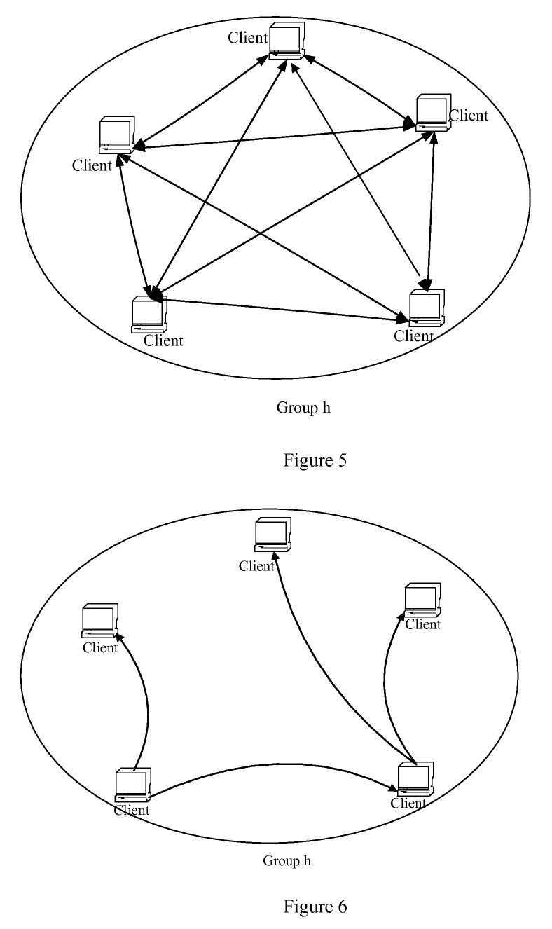

The relationship of the intra-group members is based on a complete interconnection O (n) net shape pattern, thus is a completely interconnecting network, and any device can interact to n−1 member nodes in this group, as shown in FIG. 5, but the transmission route of the member exchanging content block to other members is generally in a tree structure, as shown in FIG. 6.

The intra-group transmission control module also includes transmission decision making unit. In the content-receiving group, the transmission stream of the content block is shown as FIG. 4:

In step 201, the transmission decision making unit detects the number of the members in the group, then perform step 202;

In step 202, determining if the number of group members is larger than the predetermined value. If the number of the group members is smaller or equals to the predetermined value, performing step 204. If the number of the group members is larger than the predetermined value, performing step 203.

In step 203, controlling member to transmit the content block in multi-level distribution tree mode. The structure of the said distribution tree is dynamic, that is to say the content blocks are distributed to a group of selected members, and the said selected members are responsible for retransmitting the content blocks to the members at next level.

In step 204, controlling the member with content blocks directly to transmit them one by one to the other members of the group.

Functions of selecting the tree shape structure as the transmission route:

A. All members cooperate to transmit the content, thus reducing the delay time (The member transmits the content to n*n nodes, it takes the time of n*n*t on transmitting one by one, however, the tree shape double-level transmission only takes time of n*t; alternatively, through using the distribution tree, the supportable number of the users can be expanded from n to n*n or more during the same time of n*t);

B. Selecting the best route; if the capacity of a certain node is insufficient, then select the alternative route;

C. Bypass to reach an end point which cannot be reached directly because of some reasons (e.g. NAT).

Quality of Service (QoS) of P2P network transmission is very important. Herein, QoS is mostly to perform the supplementary transmission for the content blocks which are dropped during transmission. With the control dataset, it is convenient to request the other members in the group for transmitting the dropped content blocks. While requested, the other members should have the dropped content block. For ensuring to request successfully, it is necessary to take the following measures: the content-receiving group collects pluralities of members to one group, so that the members of the group can receive the same content blocks from the previous transmission group in the comparative same period. If the member dropped a content block, it firstly requests other members in this group to transmit the dropped content block.

During transmission, if the node waiting for the coming of content block fails in receiving the content blocks over the predetermined period, it sends to a certain node in the same group a supplementary transmission request which require the said node to transmit the dropped content block again according to the updated control dataset; if the said request fails, it sends the supplementary transmission request to the members of other groups or content source end.

The comparatively comprehensive scheme is to adopt one or the combination of the following methods:

A. The sever provides restoration;

B. Requesting the previous transmission group for transmitting the content block;

C. Requesting the members of other subgroups in this group for transmitting the content block;

D. Preferred requesting the members in this group for transmitting the content block;

E. Other methods.

The server herein is the original transmission group. In which the receiving members have not the related information about the previous transmission group, so it is very difficult to carry out method B. The typical optimized scheme is: “A+D” or “A+C+D”.

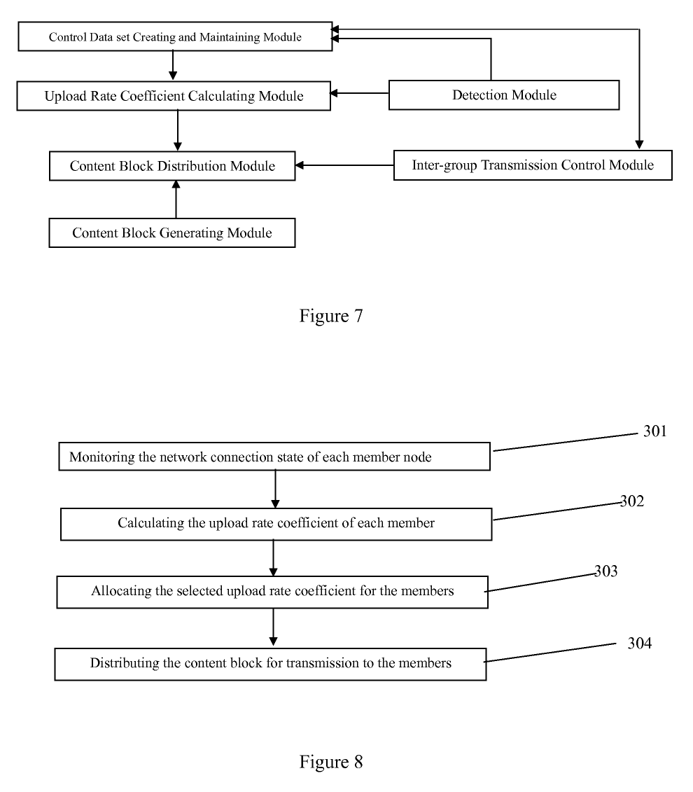

Embodiment 3 is another best application of this invention. Based on embodiment 1 and embodiment 2, it also includes a member upload rate coefficient calculating module and a content block distribution module, as shown in FIG. 7. The detection module monitors the network connection of each member node and sends the upload rate of each member node to the member upload rate coefficient calculating module for calculating module calculates the upload rate coefficient of each member node, in which the said upload rate coefficient is the ratio of the upload rate to the base rate. According to the calculated upload rate coefficient a selected upload rate coefficient is assigned and recorded in the related control datasets; the content block distribution module distributes the content block for transmission to the member nodes at the selected upload rate coefficient, the total number of the content blocks for transmission which is distributed by the content block distribution module to the member node is proportional to the selected upload rate coefficient assigned to the member node. The flow as shown in FIG. 8 includes the following steps:

In step 301, the server monitors the network connection state of each member, e.g. the upload bandwidth, and then perform step 302;

In step 302, the upload rate coefficient MUj of each member node is calculated according to the connection state of each member node, in which the upload rate coefficient is the ratio of the maximum upload rate of the member node that can be used for content transmission to the base rate Ubass. The maximum upload rate of the member in the groups of receiving the content that can be used for content transmission is divided by U_{bass} (this rate is not definitely the maximum upload rate of the node), and the result is the upload rate coefficient for the node with the member number of j:

MUⱼ=maximum upload rate of node j for content transmission/U_{bass}

And then perform step 303;

In step 303, select upload rate coefficient Uj for the member node according to the upload rate coefficient and record it on the related control dataset, and determine the transmission rate D of the content stream and the number L of the content stream at the source end. The transmission rate D of the said content stream and the number L of the content stream at the source end can be variables or constants under different conditions. The said selected upload rate coefficient Uj meets with both the following two formulas.

(U₁+ . . . +U_{N})*U_{bass}+L*D≧f(N*D)

Uⱼ≦MUⱼ

Wherein, f(N*D) is the function of N*D, which is the bandwidth required for complete download; and

D≦maximum rate for content transmission stream used by content source end when transmitting one content stream;

L*D≦sum of maximum upload bandwidth for the content transmission provided by all nodes of the content source end;

Then, perform step 304;

In step 304, distribute the content block for transmission to the member nodes according to the selected upload rate coefficient. The number of content block for transmission is proportional to the selected upload rate coefficient which is assigned by the server to this member node.

Its principle is following by:

Supposing that in a certain period the transmission rate of one content stream from the content source end is D, then the rate for a node receiving the content block from either the source end or other nodes, i.e. the download rate, should be equal to D.

Users can add the content transmission at different rates according to the network connection capability, in case that the network connection of the node which requires for content transmission service can satisfy the requirements for download of this streaming media. As for transmission of content to a group (group means a group of members), the download rate of each member of the group should be the same and equal to D. If D is variable, D cannot be larger than the lowest rate of each member of the group, in which maximum D is represented by Dₘₐₓ.

The basic conditions adapting to P2P transmission are:

Summation of upload rate provided by each member (to receive content)+summation of upload bandwidth for content transmission provided by all nodes of the content source end≧bandwidth required for complete download.

Herein, the upload bandwidth provided by the content source end (it can be a node or a group of nodes) is supposed to be L*D, that is to say the content source end can provide the content streams of L at D rate L.

The content stream means content data transmitted at a rate (e.g. D).

According to the basic conditions for P2P transmission, the solution for P2P transmission becomes to: seek for suitable L and D, and respectively assign a suitable rate to a member (to receive the content) to provide upload service.

In the P2P transmission which the content is divided into blocks, the node upload service is mainly used in the transmission of the content blocks.

To assign a suitable rate to the member for providing upload service is accomplished through distributing content blocks in different number for transmission to the members.

In particular, for the group receiving the content, the base rate is represented by U_{bass}. Generally, U_{bass} is a rate of transmitting a content package(herein it is full package which the content block with maximum length is packaged to form) in a certain period (e.g. the length of the content package is 800 bytes, time is one second, then U_{bass}=800 bps) The maximum upload rate of the user in the groups that can be used for content transmission is divided by U_{bass} (this rate is not definitely the maximum upload rate of the node), and the result is the upload rate coefficient for the node with the member number of j:

MUⱼ=maximum upload rate of i used for content transmission/U_{bass}

Uⱼ is the selected upload rate coefficient for user j in this invention, and it varies from 0 (included) to MUⱼ. If user is required to retransmit the content block, during a certain period, the system distributes content block to user j pro rata according to Uⱼ.

Supposing that the content is transmitted to N nodes, the content transmission must satisfy the following conditions:

(U₁+ . . . +U_{N})*U_{bass}+L*D≧f(N*D)

Herein, Uⱼ≦MUⱼ; D≦Dₘₐₓ; L*D≦summation of the maximum upload bandwidth for content transmission provided by all the nodes of the content source end; f (N*D) is the function of N*D, which is the bandwidth required for complete download.

Uⱼ, L and D are each variable or fixed.

By changing one or more parameter(s) of Uⱼ, L and D, the content transmission in various conditions can be realized.

Herein, (U₁+ . . . +U_{N})*U_{bass} indicates the summation of upload rate provided by each member (to receive the content). The assigned upload rate of node j is Uⱼ*U_{bass}. It should be noted that, there are various methods to distribute content blocks to nodes for uploading. Distributing content blocks according to Uj is preferred. However, in all methods it should make the nodes provide service at the assigned rate.

Furthermore, the principle of selecting Uj is that the members provide the upload bandwidth to satisfy single member's download as possible as they can. That is to say that it must conform to the following principle: selecting Uⱼ=MUⱼ if MUⱼ*U_{bass}≦D; if Uⱼ*U_{bass}≧D, selecting Uⱼ in which MUⱼ*U_{bass}>D should be satisfied. If the capability of some members is insufficient, then the transmission is undertaken cooperatively by the members with excessive upload bandwidth and content source end.

L, D and Uⱼ of each node are generally recorded on the related control dataset. They are calculated and allocated by the server, then the control dataset are updated, thus the server sends a notification indicating the control dataset updated, and the nodes perform transmission according to the notification.

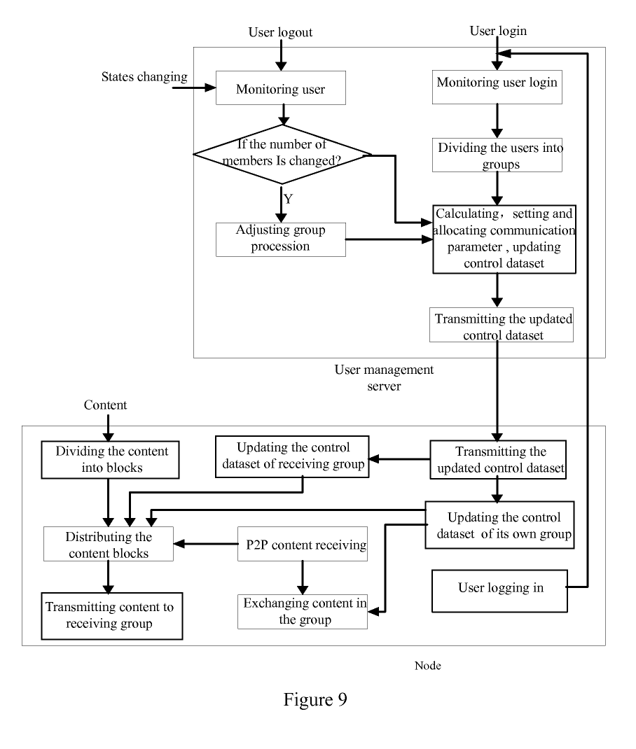

The flow chart of the embodiment is shown as FIG. 9: the server monitors the login of users (i.e. nodes). Once there are users logging in, the server divides the users into groups according to the grouping policy, calculates the upload rate coefficient MUⱼ, sets the distribution parameters and communication parameter which include the selected upload rate coefficient Uⱼ, transmission rate D of the content stream and the number L of the content stream transmitted from the content source end, updates the control dataset, and transmits the updated control dataset to the corresponding nodes; updating of the control dataset includes the updating of control dataset of the group which the node belongs to and the updating of the control dataset of the content-receiving group. According to the updated control dataset in this group, the content blocks received through P2P transmission are exchanged in group. The content to be transmitted is divided into multi-blocks, and the content blocks are distributed according to the updated control dataset of the content-receiving group, the number of content blocks distributed to the node for transmission is proportional to the selected upload rate coefficient of this node. The content blocks received through P2P transmission can be transmitted to the content-receiving group through the distribution of content blocks. During transmission, the distributed content blocks are sent respectively to the corresponding nodes, and the node received the content block is controlled to retransmit the content block to other nodes in this group.

The following is another embodiment of the invention. The server divides the nodes logged in into one or more group(s), creates the control dataset for each group, calculates the upload rate coefficient of all members depending on the control dataset, and distributes the content and transmits it depending on the upload rate coefficient of the members.

If (MU₁+ . . . +MU_{N})*U_{bass}+L*D≧f (N*D), that is to say each node has excessive upload bandwidth and keeps the original transmission rate, then the following implementation is adopted:

For convenience of illustration, simplification can be done: it takes content block as unit of the rate. Supposing that there are N members in the group, N members require to download the total number of M content blocks during certain time t. In the same way, the member with the upload rate of U_{bass} uploads one content block during the time t.

Select SUⱼ=MUⱼ if MUⱼ*U_{bass}≦D, select SUⱼ=D/U_{bass} if MUⱼ*U_{bass})>D.

Firstly, SUⱼ content blocks is distributed, to each member and the number of remained blocks to be transmitted is M′.

Then, more content blocks are distributed to the members with excessive upload capacity:

Uⱼ′=(MUⱼ-SUⱼ)/summation of the remained upload rate coefficient of all the members *M′

Uⱼ=Uⱼ′+SUⱼ

In this way, Uⱼ(j=1, 2, . . . , N) is obtained, thus the node j is required to upload Uⱼ content blocks.

Another simple and effective method is to:

Accumulate respectively the number M₁ of members at the upload rate coefficient of 1, and the number M₂ of members at the upload rate coefficient of 2, the rest steps are similar. While distributing, distribute one content block to each member (MUⱼ≧1) which can upload first. If the number of the blocks is insufficient, it distributes one more content block to the member (MUⱼ≧2) with excessive capability. If the number is still insufficient, it distributes further one more content block to the member (MUⱼ≧3) with excessive capability, the step is continued until it can get the required Mₖ, which means that it has found the minimum k, and make

(M₁+M₂+ . . . Mₖ)≧M

After obtaining k, the node j requires to upload the smaller number between MUⱼ and k of the content block.

In this way, the content block can be uploaded by the nodes with upload capacity according to their upload capacity, without extra assistance from other nodes. This alleviates the excessive load on the other nodes and uses the network bandwidth more reasonably.

The grouping policy may conform to the following principles:

1) First priority is based on the network rate: The transmission content may create pluralities of transmission stream at different rate, and different user groups can be accessed to the network according to download rate of the user;

2) Second priority is based on the content receiving start point: performing grouping according to the content start receiving point of the node;

3) Third priority is that the same property is prior, including:

Priority of stability: Performing grouping according to the stability (including on-line time, package loss rate, etc.) of the network connection of the node;

Priority of location: Determining node location according to IP address, optimize to select the nodes in the same location to add into the same group;

4) Performing grouping according to 1), 2) and 3), in which the number of members cannot be larger than the value set by the system, if the number is larger than the predetermined value, then create a new group. It is possible that pluralities of groups have the same property. For adapting to some transmission types, the member of one group can be divided into pluralities of subgroups.

There are more techniques for grouping:

When an user loges in, it firstly seeks the suitable group, and creates the new group only in the case that there is not the suitable group;

When the number of the users is up to a certain value or they wait for a certain period, it will call together the users to form a group;

If the sequence of the content received by the users is obvious, that is the number of the content block received by the users, divide the users into various groups taking the rough range of the last position for users as location, the group received part of the content is responsible for transmitting to the groups which have never received the said content;

The groups with better performance are responsible for transmitting the content to the groups with poor performance.

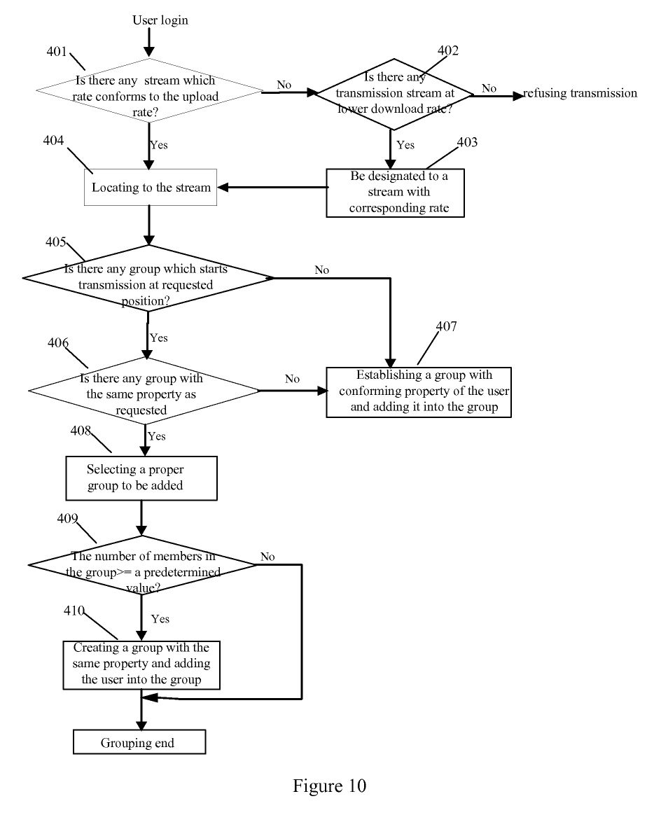

The detailed flow for grouping of this embodiment is shown as FIG. 10:

In step 401, If an user loges in, according to the network download rate of the user, it seeks a group of transmitting stream which adapts to the network download rate of the said user (in which a group of stream or transmission stream is a set of groups of using the same rate or a range of rate to transmit the content. To create a group of transmission stream normally isn't permitted rather than they are selected from the pluralities of previous groups. The group of transmitting stream may be a group with no member, and if it happens and users with a suitable network download rate log in, then create a real group.). If such group of transmitting stream is found, then step 404 is performed; if no, then step 402 is performed.

In step 402, seeking if there is a transmission stream at lower download rate. If no, refusing to transmit the stream to this user; if yes, then performing step 403, in which the users are designated to the corresponding transmission streams with lower download rate, and then performing step 404;

In step 404, the proper transmission stream is located to the user, and then performing step 405;

In step 405, seeking if there are groups with the same start point as the position in which this user starts to request transmission in the located stream. These groups are known as the same location groups, i.e. these groups request to start transmission at the same position. If yes, performing step 406; if no, performing step 407;

In step 406, seeking if there are groups with the same property as requested by the user in the same location group. These groups are known as the same property group. The property of the group is mentioned as the above principle 3). If yes, perform step 408; if no, perform step 407;

In step 407, creating a group with property conforming to this user and add this user to the newly created group;

In step 408, selecting the suitable group from the group with same property and add this user to the said group. The suitable group indicates the group with the minimum number of members in the group with same property, and then perform step 409;

In step 409, determining if the number of member of this group which this users joins is larger than or equals to the predetermined value. If yes, perform step 410; if no, end grouping operation without any treatment;

In step 410, creating a group with the same property and add this user to the newly created group, and then end grouping operation.

When a user logs out, if there are pluralities of groups with same property and the number of members in the same property group is small, the number of the groups should preferredly be decreased. In addition, when it is possible that the number of the groups is decreased, some groups can be combined in order for the reduction of the number of the groups.

Embodiment 4: alternative content distribution between multi users includes the following steps:

1. Creating the control dataset for the pluralities of related nodes connected to the computer network in P2P mode; the pluralities of related nodes are connected in P2P (peer-to-peer) mode on computer network; one of features related to them is that each node maintains a same control dataset (the table formed by a set of information related to users), the control dataset consists of the necessary data, transmission state used for intercommunication of each node and the mark indicating changes of control dataset;

2. The server is responsible for monitoring the connection, disconnection and communication state of pluralities of nodes, in which it records the changes in the control dataset and marks the control dataset after changed; maintains the update of the control dataset of each node; the server can be one or a plurality of nodes, alternatively a dedicated server that is not a node;

3. The node for the distribution of original content divides them into a plurality of blocks, packages them with attached identification of the node and transmits the package to other nodes, wherein when the node packages the content block, it adds the related information, especially the identification of the node, and then perform transmission;

4. The transmission scheme adopts the embodiment 1 or the combination of embodiment 1, embodiment 2 and embodiment 3;

5. The nodes received content packages send messages indicating that they have received the said packages to the nodes with these identifications according to the node identifications in the content packages;

6. When the nodes of distributing original content fail to receive the messages of indicating the nodes of receiving the content have received the said content package over the predetermined time period, they retransmit the said content package to the said nodes of receiving the content package.

This embodiment can be used in the following fields:

A. Audio/video stream multicasting of each node in TV conference.

B. games in the network, in which any member of a group send information and data to other group of members for cooperatively handling events.

C. Send instant messages to a group with a plurality of nodes.

D. P2P solution involved in cooperatively performed task by work group.

This embodiment supports that members in a group distribute its own content, and the server maintaining the control dataset can be separated from the server transmitting the content.

This invention can be used for simple P2P file/content transmission, and it consists of the following steps:

The user login server selects a certain number of users with the same property or users logged in within a certain period to form a group, according to which access earlier, based on the control dataset and supporting a small number of users and shorter period of waiting;

At the beginning, the server distributes the control dataset of the group to the users in this group, due to the small number of members, it may directly transmit the control dataset to each member; alternatively, it may transmit the control dataset to part of the members, and the part of members is responsible for transmitting the received control dataset to the other members;

After that, the server updates the control dataset of each member in real time through adopting to transmit the changed part of the control dataset in P2P mode;

The server divides the file/content into content blocks according to the control dataset, transmits the said content blocks respectively to each member of the group. The members retransmit the content blocks from the server to other members according to the control dataset;

After a certain time period, if the members still fail to receive the content blocks supposed to be arriving, ,they request the server or other members for supplementary transmission of the content block;

After completing the transmission of file/content or after a predetermined time period, this group is deleted.

This invention can be used for transmitting the file with integrated content that is to completely transmit the content in file format to a large number of nodes. It consists of the following steps in particular:

Divide the content to be transmitted into a plurality of parts;

Users receive the data in approximately ordered way, in which the users has content storage capacity, so that they can record the block number of the content block received at last;

During users log in, they should attach the block number received at last, according to which they determine which content part they are belonged to, and the users received the same part of content are formed to the session group ;

The group received the content part is responsible for transmitting the received content to the group requiring for it. If there is no group with received content part, the server transmits the content. The selectable methods are: the group which has received the previous n−1 parts of content and is receiving content parts from part n is supposed to be Gₙ, when Gₖ(k<n) requests for transmission, it will search the first group suitable for being in charge of the transmission from Gₖ₊₁;

As for the supposed Gₙ, the number n of the group is dynamic, after Gₙ finishes receiving the part n content and is preparing for receiving and storing the part n+1 content, Gₙ changes to Gₙ₊₁.

Each transmission group should satisfy the requirement of the transmission rate. If the upload rate of a certain node or a certain transmission group is significantly changed, the said node or transmission group is located to the corresponding transmission stream; or if the transmission group can not satisfy the need of the transmission rate, the transmission rate of the content stream is changed.

Compared with P2P stream media, the file transmission method is more like a P2P file-sharing system because its real-time performance is poor, but compared with the traditional P2P file sharing system, its transmission blocks are in rough order, and it can satisfy the requirement of “download while operating”.

The file transmission method of this invention supports an enormous number of the users. It is most important that requirement of bandwidth is insignificant here, only one to two original content stream(s) needed. The ratio of its expanded concurrent stream can be very large, equals to:

(1+M2+ . . . +Mk+ . . . +Mn)/L1

In which:

Mk: The number of members in group k

L1: the number of content stream from the server

Thus, the main task of the file transmission method is changed to manage users. Comparatively, it is also an easy task.

In the embodiment mentioned above, it makes the members received the transmission content from the upper level group participate in the transmission as possible as it can. It is possible that all members in the content-receiving group participate in receiving. Alternatively, it is determined by the mechanism to exclude those members which temporarily lost network transmission ability especially the upload ability at some moments. The upload rate for each member participating in transmission in the content-transmitting group when transmitting is coordinated, so that the members of content-receiving group can download the content block at the predetermined rate.

This invention is also applicable in live audio/video broadcast or fast VOD (Video-On-Demand).

The modules or streams mentioned above can be programmed. This program can be embedded on a computer, including server computer.

The program designed according to the modules or flows mentioned above can be stored in the external readable storage medium. The storage medium can be floppy disk, CD-ROM, hard disk, tape recording medium, semiconductor of IC card or other optical recording mediums (e.g. DVD or PD), or magnetic recording medium. The server system providing network connection can also be used as the readable medium of recording program. The medium also includes the electrical, light, audio transmission signals or signals in other forms (e.g. carrier wave, infrared signal, digital signal, etc.)

In summary, this invention has three main characteristics:

1. Fully cooperative transmission: In virtue of the characteristics and functions of the P2P, it makes full and reasonable use of the capacity of members, in particular the upload communication ability. Cooperative transmission can reduce the burden on the members responsible for transmission.

2. Grouping is flexible and practicable. For example:

The relationship between the content-transmitting groups can be in series:

Server=>Gₙ=>Gₙ₋₁=> . . . =>G₁

With exception of requiring the first group to transmit content through the server, other groups can receive the content retransmitted by another group, so that smaller network bandwidth can be suitable for large scale of users. In this grouping method, the group received part of the content is responsible for transmitting the said content to the groups which have never received the content; it is also feasible that the groups with better performance is responsible for transmitting the content to the groups with poor performance, and thus the integrated effect is enhanced.

If the members have content storage capacity and can delay to transmit, the content-receiving group requests the content-transmitting group for content transmission within a latter time period.

Transmission relationship can be one-to-more:

Gᵢ= [symbol] (Gⱼ₁, Gⱼ₂, . . . Gⱼₖ)

This grouping method can make use of the benefits of grouping according to property, and it can make the system easily be expended and support a large scale of users as well.

3. Active transmission.

Active transmission can increase the transmission rate, at the same time the transmission procedure can be controlled.

The transmission method can control the upload number of certain members in the content-receiving group to lower the pressure caused by insufficient capacity for some members.

The system adopting this invention can be the large scale, flexible, robust, efficient, reliable, safe, load-balancing and rapid system. It can make full use of the communication ability of each node, characterized in simple structure, easy realization and expansion. It can be adapted to various demands for actual P2P function.

Firstly, the system is flexible. The large number users are treated cooperatively by many groups, in which the number of groups is decided according to the number of users.

The system can be in large scale. The number of users distributing one content in the system equals to:

G1+G2+ . . . +Gk+ . . . +Gn

In which:

Gk: The number of member of the group k

If n>200 and the average number of users is larger than 5000, the number of the user for content distribution can equal to or be larger than 10⁶.

The system is efficient. This embodies in that the system is accurate and controlled, each member in the group maintains the same control dataset to achieve accurate transmission.

The system is reliable, because there is a repair method.

The system is safe. That is because users are required for logging in to access to the system. When the users access to the system number of the users, is verified. Only the legal users can access to the system and conduct content transmission.

The system is load-balancing, because of the 0 (n²) net shape pattern.

The system is rapid. The exchange of intra-group members generally

1. A method for content transmission on P2P network comprising the following steps:
A1. dividing a content to be transmitted into a plurality of blocks and marking each of them;
B1. dividing a node of participating in the content transmission into at least two groups;
C1. selecting a part or all members from a content-transmitting group with blocks to participate in an allocation of the blocks, and the members respectively send the allocated blocks to part or all members of a content-receiving group requiring the blocks;
D1. controlling the members of the content-receiving group who have received the said blocks to retransmit the content blocks to other members in the group.

2. The method for content transmission on P2P network according to claim 1, wherein the content-receiving group received the blocks in the step D1 becomes a new content-transmitting group and transmit the blocks to other groups according to the step C1.

3. The method for content transmission on P2P network according to claim 1, wherein further including the following grouping steps:
B11. when detecting there is a node logging in, locating the node to a stream with a rate in conformity with its download rate;
B12. searching for a group within the same location as a starting point of the transmission requested by the node;
B13. searching for a group with the same property as requested by the node in the group with the same location;
B14. selecting a proper group in groups with the same property to be added by the node.

4. The method for content transmission on P2P network according to claim 3, wherein in the step B11, if there is no stream with a rate in conformity with its download rate and such a stream cannot be created, then the node will be located to a stream with a lower download rate.

5. The method for content transmission on P2P network according to claim 4, wherein if there are no group with the same location as mentioned in the step B12, or there are no group with the same property as mentioned in the step B13, then a new group whose property is in conformity with the node is created and the node is added into the newly created group.

6. The method for content transmission on P2P network according to claim 5, wherein further including after the step B14 that: if the number of members of a group which the node is added into is larger than or equals to a predetermined value, then create a new group with the same property and add the node into the newly created group.

7. The method for content transmission on P2P network according to claim 1, wherein selection of a predetermined policy of the transmission between two groups includes but is not limited to the following principles:
A. it is preferred that a group which has received part of content is in charge of transmitting the content parts to a group which has never received any part of the content;
B. it is preferred that a group which is closer to a source end of the previous level is in charge of transmitting content parts to a group which are farther, the main method of determining the distance is to evaluate an average time that it takes for a member of a group sending data to a source end of the previous level and receiving data from it;
C. a group with better transmission quality is in charge of sending contents to a group with worse transmission quality;
D. a group with higher transmission rate is in charge of sending contents to a group with lower transmission rate;
E. a group that is created earlier is in charge of sending contents to a group that is created later.

8. The method for content transmission on P2P network according to claim 3, wherein without changing original groups, dividing one of existing groups into two or more groups.

9. The method for content transmission on P2P network according to claim 2, wherein the content-transmitting group should include at least one member and the member of the group can be a server.

10. The method according to claim 2, wherein a corresponding control dataset of recording property of each node in a group is created for each group, in which the control dataset at least includes necessary data, transmission state, group property for the communications between nodes and marks to indicate the changes of the control dataset.

11. The method for content transmission on P2P network according to claim 10, wherein in the step D1 when the members of the content-transmitting group send the content blocks, they allocate the content blocks depending on a control dataset of the content-transmitting group and a control dataset of the content-receiving group; when the member of the content-receiving group in the step E1 receives content blocks from the content-transmitting group, it sends the received content blocks to other members in its own group depending on the control dataset in its own group.

12. The method for content transmission on P2P network according to claim 11, wherein further including the following steps: control members in a same group to have a same control dataset, and control a transmission member of a content-transmitting group have a control dataset of the content-receiving group.

13. The method for content transmission on P2P network according to claim 12, wherein further including the following steps of maintaining control dataset:
A2. a server monitors the connection, disconnection and communication state of nodes that have participated in sending contents; the changes are indicated in the control dataset; marks the control dataset after changed;
B2. sending the changed control dataset to each node.

14. The method for content transmission on P2P network according to claim 13, wherein in step B2, the method of the server for sending the changed control dataset to a node to be updated includes the following steps:
A3. relying on the existing control dataset, the server divides the control dataset or changed part of the control dataset or variation generated from the control dataset into blocks, and respectively sends each block to part or all members of the group;
B3. if a member has no previous control dataset, the server sends the whole corresponding control dataset or variation generated from the corresponding control data to the member.

15. The method for content transmission on P2P network according to claim 11, wherein when sending the content blocks, the content blocks are packaged and attached with additional information including content marks and block number and transmission level parameter for indicating if a receiving part requires retransmission and which transmission mode will be used, so that the receiving part can receive and recombine them.

16. The method for content transmission on P2P network according to claim 15, wherein further including the following steps: after a node received data , the block number of the last received content block is recorded; when the node logs in again attached with the block number of the last received content block , determining which part of the content it belongs to according to the block number, and combing the nodes belonging to a same part of content into a session group; the group that has received the content blocks is in charge of sending the content blocks to groups requiring them, and if a group that has received required content blocks is not found, the content blocks is sent by the server.

17. The method for content transmission on P2P network according to claim 16, wherein further including the following steps: the transmission state of a content block received by the member on a control dataset is recorded, and the transmission member determines whether the receiving member already has the content blocks before transmitting them according to the transmission state of the content blocks, and if the member already has the blocks, the content to be transmitted this time should be null.

18. The method for content transmission on P2P network according to claim 11, wherein the method further includes the following steps when content blocks are transmitted in a content-receiving group: the members in the group are divided into a plurality of subgroups depending on the control dataset in the group ,in which each subgroup includes at least one member; when transmitting the content blocks, the content-transmitting group sends the same content blocks to all members of a certain subgroup in the content-receiving group at the same time.

19. The method for content transmission on P2P network according to claim 18, wherein the content blocks are sent in the content-receiving group according to the following steps: if the number of the members in the group is smaller than or equals to the predetermined value, the said member will send the content blocks one by one directly to other members in the group; if the number of the members in the group is larger than the predetermined value, the said member will send the content blocks in tree-shape multilevel distribution mode. The structure of the said tree-shape distribution is dynamic.

20. The method for content transmission on P2P network according to claim 18, wherein including the steps of supplementary transmission: during transmission, if the node waiting for the coming of content block fails in receiving the content blocks over the predetermined period, it sends to a certain node in the same group a supplementary transmission request which require the said node to transmit the dropped content block again according to the updated control dataset; if the said request fails, it sends the supplementary transmission request to the members of other groups or content source end.

21. The method for content transmission on P2P network according to claim 1, wherein further including the following steps:
The server monitors the network connection of each member node and calculates the upload rate coefficient MUj of each member node; assigning upload rate coefficient Uj for the member node according to the upload rate coefficient, in which the said upload rate coefficient MUj is the ratio of the max upload rate that can be used for content transmission of the member node to the base rate U_{bass}, in which j=1, 2 . . . N, and N is the number of the nodes that have participated in the transmission; determining the transmission rate D of the content stream and the number L of the content stream at the source end, in which the transmission rate D of the said content stream and the number L of the content stream at the source end can be variables or constants under different conditions, and the said selected upload rate coefficient Uj satisfies both of the following two relations:
(U₁+ . . . +U_{N})*U_{bass}+L*D≧f(N*D)
Uⱼ≦MUⱼ
wherein, f (N*D) means the function of N*D, which is the bandwidth required for total download; and
D≦maximum transmission rate of content stream used by the content source end when transmitting one content stream;
L*D≦sum of maximum upload bandwidth for the content transmission provided by all the nodes of the content source end;
distributing the content blocks for transmission to the member node according to the selected upload rate coefficient, in which the number of content blocks for transmission is proportional to the selected upload rate coefficient assigned by the server to the member node.

22. The method for content transmission on P2P network according to claim 1, wherein further including the following steps:
A4. control data set for many relevant nodes that are connected in P2P mode to the computer network is created;
B4. the server controls the connection, disconnection and communication state of the nodes, and the changes are indicated in the control dataset; marking the changed control dataset and maintaining the updating of the control dataset of each node;
C4. the node for distributing original contents divides the original contents into a plurality of blocks, and packages them attached with the node identification and send the said packages to other nodes:
D4. the nodes received content packages send messages indicating that they have received the said packages to the nodes with these identifications according to the node identifications in the content packages;
E4. when the nodes of distributing the original content fail to receive the messages of indicating the nodes of receiving the content have received the said content packages over the predetermined time period, they retransmit the said content packages to the said nodes of receiving the content packages

23. A device for content transmission on P2P network comprising:
content blocks generating module, for dividing the content required to be transmitted into a plurality of content blocks and marking each content block;
group generating module, for dividing the nodes transmitting the contents into at least two groups; transmission module, for transmitting the contents to the nodes by blocks;
Inter-group transmission control module, for selecting part or all the members from the content-transmitting groups with content blocks to participate in the distribution of the content blocks, and controlling the member to respectively transmit the distributed content blocks to part or all members of the content-receiving groups that require the content blocks through transmission mode; Intra-group transmission control module, for controlling the members received the content blocks in the content-receiving groups to retransmit the content blocks to other members that require the content blocks in the group.

24. The device for content transmission on P2P network according to claim 23, wherein further including detection module and control dataset creating and maintaining module, wherein, the said detection module monitors the connection, disconnection and communication state of the nodes transmitting the content; the control dataset creating and maintaining module is for creating the corresponding control dataset of the properties of each node in the recording group for each group, in which the control dataset at least includes the necessary data for the communications between the nodes, transmission state, group property and the marks for indicating the change of the control dataset; control dataset creating and maintaining module updates the control dataset according to the changes monitored by the detection module and marks the control dataset after changed; content block generating module divides the changed part of the updated control dataset or the variation of the control dataset into blocks, and inter-group transmission module respectively transmits the blocks to part or all members of the group; intra-group transmission control module controls the members to retransmit the blocks received from the server to other members in the group.

25. The device for content transmission on P2P network according to claim 24, wherein the intra-group transmission control module includes a grouping unit in the group, which are used for dividing the members in the group into a plurality of subgroups according to the control dataset in the group, each subgroup including at least one member. When transmitting group is sending content blocks, the same content blocks should be transmitted to all members in the certain subgroup of the content-receiving group at the same time.

26. The device for content transmission on P2P network according to claim 25, wherein the intra-group transmission control module also includes a transmission decision making unit, which is used for detecting the number of the members in the group and for controlling the said members with the content blocks to directly transmit the content blocks to other members in the group one by one when the number of the members is lower than or equals to the predetermined value; and for transmitting the content blocks in multilevel distribution tree mode when the number of the members is higher than the predetermined value, in which the said distribution tree is dynamically structured.

27. The device for content transmission on P2P network according to claim 23, wherein further including a member upload rate coefficient calculating module and a content block distribution module. The said detection module monitors the network connection of each member node and transmit the upload rate of each member node to the member upload rate coefficient calculating module for calculating the upload rate coefficient of each member node, in which the said upload rate coefficient is the ratio of the max upload rate of the member node that can be used for transmission to the base rate, a selected upload rate coefficient is assigned according to the calculated upload rate coefficient and is recorded in the relevant control dataset; the content block distribution module distributes the content blocks that can be sent to the member node according to the selected upload rate coefficient, and the number of the said content blocks that can be sent is proportional to the selected upload rate coefficient of the member node given by the server.

28. A computer readable medium embedded a computer executable program, the program is executed by a computer to accomplish the following functions:
dividing a content to be transmitted into a plurality of blocks and mark each of them;
dividing a node of participating in the content transmission into at least two groups;
selecting part or all members from a content-transmitting group with the blocks to participate in the allocation of the blocks, and the said members respectively send the blocks to be allocated to part or all members of a content-receiving group for requiring the said blocks;
controlling the said members of the content-receiving group who have received the said blocks to retransmit the said content blocks to other members in the group

29. The computer readable medium according to claim 28, wherein the said program is executed by the computer to accomplish the following functions:
creating a corresponding control dataset of recording the property of each node in the group for each group, in which, the control dataset at least includes the necessary data for the communications between the nodes, transmission state, group property and marks to indicate the changes of the control dataset;
controlling the members in the same group to have the same control dataset, and the transmission member of the content-transmitting group to have the control dataset of the said content-receiving group;
when the members of the said content-transmitting group send the said content blocks, they allocate the content blocks depending on the control dataset of the content-transmitting group and the control dataset of the content-receiving group; when the member of the said content-receiving group in step E1 receives the content blocks from the content-transmitting group, it sends the received content blocks to other members in its own group depending on the control dataset in its own group.

30. The computer readable medium according to claim 29, characterized in that the said program is executed by the computer to accomplish the following functions: dividing the members in the group into subgroups depending on the control dataset in the group and each subgroup includes at least one member; when sending content blocks, the transmitting group transmits the corresponding content blocks to all the members of a subgroup in the group at the same time.

31. The computer readable medium according to claim 30, wherein the said program is executed by the computer to accomplish the following functions: Transmission mode is determined according to the number of the members in the group, in which if the number of the members in the group is smaller than or equals to the predetermined value, the said member will send the content blocks one by one directly to other members in the group; if the number of the members in the group is larger than the predetermined value, the said member will send the content blocks in tree-shape multilevel distribution mode. The structure of the said tree-shape distribution is dynamic.

32. The computer readable medium according to claim 28, wherein the said program can also achieve the following functions through execution of the computer:
The server monitors the network connection of each member node and calculates the upload rate coefficient MUⱼ of each member node; assigning upload rate coefficient Uⱼ for the member node according to the upload rate coefficient, in which the said upload rate coefficient MUⱼ is the ratio of the max upload rate that can be used for content transmission of the member node to the base rate U_{bass}, in which j=1,2 . . . N, and N is the number of the nodes that have participated in the transmission; determining the transmission rate D of the content stream and the number L of the content stream at the source end, in which the transmission rate D of the said content stream and the number L of the content stream at the source end can be variables or constants under different conditions, and the said selected upload rate coefficient Uj satisfies both of the following two relations:
(U₁+ . . . +U_{N})*U_{bass}+L*D≧f(N*D)
Uⱼ≦MUⱼ
wherein, f (N*D) means the function of N*D, which is the bandwidth required for total download; and
D≦maximum transmission rate of content stream used by the content source end when transmitting one content stream;
L*D≦sum of maximum upload bandwidth for the content transmission provided by all the nodes of the content source end;
distributing the content blocks for transmission to the member node according to the selected upload rate coefficient, in which the number of content blocks for transmission is proportional to the selected upload rate coefficient assigned by the server to the member node.

33. A method for content transmission on P2P network comprising the following steps:
A5. dividing the content to be transmitted into a plurality of blocks and mark each of them;
B5. dividing the nodes transmitting the content into at least two groups;
C5. selecting part or all members from the transmitting groups to participate in the distribution of the blocks, and the selected members respectively transmit the distributed blocks to part or all members of the corresponding content-receiving groups which require the said content blocks;
D5. controlling the members received the blocks in the content-receiving groups to retransmit the content blocks to other members requiring the content blocks in the group;
in step C5 and D5, content blocks are distributed through the following steps when sending content blocks:
E5. the server monitors the network connection of each member node and calculates the upload rate coefficient MUⱼ of each member node; assign an upload rate coefficient Uⱼ for the member node according to the upload rate coefficient, and the said upload rate coefficient MUⱼ is the ratio of the max upload rate that can be used for content transmission of the member node to the base rate U_{bass}, in which j=1,2 . . . N, and N is the number of the nodes that have participated in the transmission; determine the transmission rate D of the content stream and the number L of the content stream at the source end. The transmission rate D of the said content stream and the number L of the content stream at the source end can be variables or constants under different conditions. The said selected upload rate coefficient Uⱼ satisfies both of the following two relations:
(U₁+ . . . +U_{N})*U_{bass}+L*D≧f(N*D)
Uⱼ≦MUⱼ
wherein, f (N*D) means the function relating to N*D, and is the bandwidth required for total download; and
D≦maximum transmission rate of content stream used by the content source end when transmitting one content stream;
L*D≦sum of maximum upload bandwidth for the content transmission provided by all the nodes of content source end;
F5. Distributing the content block for transmission to the member nodes according to the selected upload rate coefficient. The number of content block for transmission is proportional to the selected upload rate coefficient assigned by the server to this member node.

34. A device for content transmission on P2P network comprising: content block generating module: for dividing the content required to be transmitted into a plurality of content blocks and marking each content block; group generating module: for dividing the nodes transmitting the contents into at least two groups; transmission module: for transmitting the content including the control dataset to the nodes by blocks;
inter-group transmission control module: for selecting part or all the content-transmitting groups with content blocks to participate in the distribution of the content blocks, and controlling the member to respectively transmit the distributed content blocks to part or all members of the content-receiving groups that require the content blocks through transmission module;
intra-group transmitting control module: for controlling the members that have received the content blocks in the content-receiving groups to retransmit the content blocks to other members that require the content blocks in the group;
member upload rate coefficient calculating module: it calculates the upload rate coefficient of each member node according to the upload rate of each member node, the said upload rate coefficient is the ratio of the max upload rate that can be used for transmission to the base rate of the member node, and it distributes a selected upload rate coefficient according to the calculated upload rate coefficient.
content block distribution module: it distributes the content blocks for transmission to the member node according to selected upload rate coefficient, and the total number of content blocks for transmission distributed to the member nodes is proportional to the selected upload rate coefficient assigned to the member node.

35. A method for content transmission on P2P network including the following steps:
A6. regularly checking on the content with continuous changes. In cases of change, mark the content to indicate the content change at this moment, and extract the changed content part, generate variation of the content, content variation includes the mark indicating the content change;
B6. taking the variation of the content as the transmission content, divide the said transmission content into a plurality of content blocks and mark each of them;
C6. dividing the node transmitting the content into at least two groups;
D6. selecting part or all members from the transmitting groups to participate in the distribution of the blocks, and the selected members respectively transmit the distributed blocks to part or all members of the corresponding content-receiving groups which require the said content blocks;
E6.controlling the members received the blocks in the content-receiving groups to retransmit the content blocks to other members requiring the content block;

36. The method for content transmission on P2P network according to claim 35, wherein:
after step E6, the members obtained the variation of the content generates the changed contents based on the variation of the content, it includes the flowing steps:
F61. according to the mark indicating the content change, determining if the member has the corresponding old content. If yes, performing step F62. Otherwise, performing step F63;
F62.generating the new content after changed, and then performing step F64, based on the variation of the content and the corresponding old content;
F63. retrieving the corresponding old content and then performing step F62;
F64. saving the new content after changed and the mark indicating the content for using later.
